(19) United States
(12) Patent Application Publication
(10) Pub. No.: US 2006/0268671 A1
(43) Pub. Date: Nov. 30, 2006

(54) Efficient channel tracking in packet based OFDM systems

(75) Inventor: Justin Coon, Bristol (GB)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/391,322

(22) Filed: Mar. 29, 2006

(30) Foreign Application Priority Data
Mar. 30, 2005 (GB) 0506421.7

(51) Int. Cl. H04J 11/00

(52) U.S. Cl. 370/203

(57) ABSTRACT

An OFDM signal transmitted from an OFDM transmitter, the signal having a payload portion comprising a first number of data symbols and a second number of padding symbols such that the combined number of data symbols and padding symbols equates to an integer number of OFDM symbols and wherein the padding symbols comprise training symbols

This invention relates to signals, apparatus and methods for use in OFDM (Orthogonal Frequency Division Multiplexed) communication systems. More particularly it relates to channel estimation in systems with a plurality of transmitter antennas, such as MIMO (Multiple-input Multiple-output) OFDM systems.

The current generation of high data rate wireless local area network (WLAN) standards, such as Hiperlan/2 and IEEE802.11a , provide data rates of up to 54 Mbit/s. However, the ever-increasing demand for even higher data rate services, such as Internet, video and multi-media, have created a need for improved bandwidth efficiency from next generation wireless LANs. The current IEEE802.11a standard employs the bandwidth efficient scheme of Orthogonal Frequency Division Multiplex (OFDM) and adaptive modulation and demodulation. The systems were designed as single-input single-output (SISO) systems, essentially employing a single transit and receive antenna at each end of the link. However within ETSI BRAN some provision for multiple antennas or sectorised antennas has been investigated for improved diversity gain and thus link robustness.

Hiperlan/2 is a European standard for a 54 Mbps wireless network with security features, operating in the 5 GHz band. IEEE 802.11 and, in particular, IEEE 802.11a , is a US standard defining a different networking architecture, but also using the 5 GHz band and providing data rates of up to 54 Mbps. The Hiperlan (High Performance Radio Local Area Network) type 2 standard is defined by a Data Link Control (DLC) Layer comprising basic data transport functions and a Radio Link Control (RLC) sublayer, a Packet based Convergence Layer comprising a common part definition and an Ethernet Service Specific Convergence Sublayer, a physical layer definition and a network management definition. For further details of Hiperlan/2 reference may be made to the following documents, which are hereby incorporated by reference: ETSI TS 101 761-1 (V1.3.1): “Broadband Radio Access Networks (BRAN); HIPERLAN Type 2; Data Link Control (DLC) Layer; Part 1; Basic Data Transport Functions”; ETSI TS 101 761-2 (V1.2.1): “Broadband Radio Access Networks (BRAN); HIPERLAN Type 2; Data Link Control (DLC) Layer; Part 2: Radio Link Control (RLC) sublayer”; ETSI TS 101 493-1 (V1.1.1): “Broadband Radio Access Networks (BRAN); HIPERLAN Type 2; Packet based Convergence Layer; Part 1: Common Part”; ETSI TS 101 493-2 (V1.2.1): “Broadband Radio Access Networks (BRAN); HIPERLAN Type 2; Packet based Convergence Layer; Part 2: Ethernet Service Specific Convergence Sublayer (SSCS)”; ETSI TS 101 475 (V1.2.2): “Broadband Radio Access Networks (BRAN); HIPERLAN Type 2; Physical (PHY) layer”; ETSI TS 101 762 (V1.1.1): “Broadband Radio Access Networks (BRAN); HIPERLAN Type 2; Network Management”. These documents are available from the ETSI website at www.etsi.org.

Orthogonal frequency division multiplexing is a well-known technique for transmitting high bit rate digital data signals. Rather than modulate a single carrier with the high speed data, the data is divided into a number of lower data rate channels each of which is transmitted on a separate subcarrier. In this way the effect of multipath fading is mitigated. In an OFDM signal the separate subcarriers are spaced so that they overlap and the subcarrier frequencies are chosen that so that the subcarriers are mutually orthogonal, so that the separate signals modulated onto the subcarriers can be recovered at the receiver. One OFDM symbol is defined by a set of symbols, one modulated onto each subcarrier (and therefore corresponds to a plurality of data bits). The subcarriers are orthogonal if they are spaced apart in frequency by an interval of 1/T, where T is the OFDM symbol period.

An OFDM symbol can be obtained by performing an inverse Fourier transform, preferably an Inverse Fast Fourier-Transform (IFFT), on a set of input symbols. The input symbols can be recovered by performing a Fourier transform, preferably a fast Fourier transform (FFT), on the OFDM symbol. The FFT effectively multiplies the OFDM symbol by each subcarrier and integrates over the symbol period T. It can be seen that for a given subcarrier only one subcarrier from the OFDM symbol is extracted by this procedure, as the overlap with the other subcarriers of the OFDM symbol will average to zero over the integration period T.

Often the subcarriers are modulated by QAM (Quadrature Amplitude Modulation) symbols, but other forms of modulation such as Phase Shift Keying (PSK) or Pulse Amplitude Modulation (PAM) can also be used. These modulation forms are also referred to as constellation mappings and will essentially map a number of data bits to a series of constellation symbols. Depending on the modulation chosen one constellation symbol may represent more than one data bit (e.g. in Quadrature PSK modulation there are two bits per constellation symbol).

To reduce the effects of multipath OFDM symbols are normally extended by a guard period at the start of each symbol. Provided that the relative delay of two multipath components is smaller than this guard time interval there is no inter-symbol interference (ISI), at least to a first approximation.

The state of the wireless channel varies over time (e.g. due to movement by the transmitter, the receiver, or even people, cars, and similar objects). Therefore, in many mobile, wireless communication systems it is necessary to estimate and track the state of the channel between the transmitter and receiver in order to recover the transmitted message data.

Typically, channel estimation is performed by transmitting training sequences that are known to both the transmitter and receiver and then using these sequences at the receiver to estimate the current channel state.

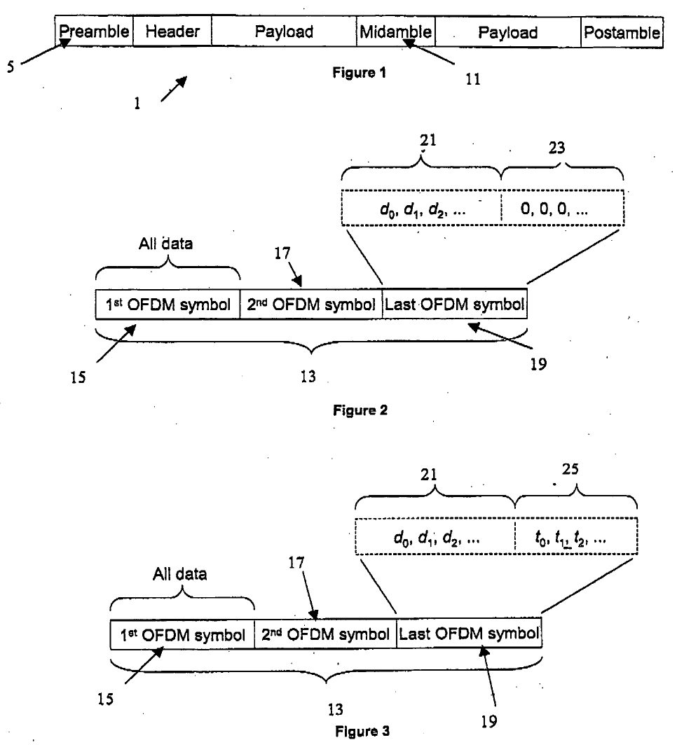

FIG. 1 shows a typical example of the structure of a packet 1 transmitted in an OFDM system.

Message data is carried in a payload portion 3 of the packet 1. The payload portion 3 is preceded in this example by preamble 5 and header 7 portions and is followed by a postamble portion 9. A midamble portion 11 is depicted inserted into the body of the payload portion 3. It is noted that an OFDM packet may comprise some or all of the pre-, mid- and post-amble portions depending on the communication system in question.

The pre, mid and postable portions are used for a variety of tasks such as gain timing and resolving antenna diversity etc. The midamble section may also be used to allow a system to regain synchronisation in the event reception is interrupted at the receiver side.

The header portion comprises information relating to the structure of the data packet, e.g. packet length, code rate, scrambler initialisation, and check sequences.

In packet-based OFDM systems the preamble is typically utilised in channel estimation by inserting a redundant training sequence into the preamble portion. In some cases, training sequences are also inserted into the midamble and postamble portions to aid the channel estimation process. The presence of such additional training information can improve the performance of a system by keeping the estimates of the channel state information and other similar parameters up to date.

The papers “Analysis of end-of-burst degradation in the OFDM UL PHY under mobile conditions,” by R. Yaniv and T. Kaitz (IEEE 802.16 Broadband Wireless Access Working Group, C802.16d-04/52, 2004) and “Ranging postamble for OFDMA,” by S. Cai et al. (IEEE 802.16 Broadband Wireless Access Working Group, C802.16e-04/400, 2004) illustrate packet based systems wherein mid and post ambles are used.

In communication systems relevant to the present invention a “layered” design is used in which the various layers perform certain functions. The layers include the Physical, Medium Access Control (MAC)/Link and Network Layers.

The Physical layer deals with the physical means of sending data over a communications medium. The MAC Layer controls access to the Physical layer and shares it among many users, while the Link Layer uses procedures and protocols to carry data across it (the Link Layer also detects and corrects transmission errors). Finally, the Network Layer is responsible for routing within the wireless network, as well as for determining how data packets are transferred between modems.

It is noted that the amount of data that is passed down through the various layers to the physical layer rarely results in an integer number of symbols, Consequently the data portion of a packet in an OFDM system (the payload portion of FIG. 1) is generally padding with zero bits in order that the total number of symbols in the payload portion (data symbols plus padding symbols) equals an integer number of OFDM symbols.

The number of constellation symbols, N, per OFDM symbol is generally chosen based on the particular requirements that the communication system needs to operate under. Although it is not a requirement, any value of N that is a power of two is generally preferable since this aids hardware implementation. Systems with N=64, 128 and 1024 are known in the art. For example, IEEE 802.11a and HiperLAN/2 systems utilize N=64 subcarriers, MBOA proposal specifies N=128, and Digital Audio Broadcasting (DAB) supports N=256, 512, 1024, and 2048.

As mentioned above OFDM systems generally incorporate an inverse-Fast Fourier Transform component and it is also noted that such an IFFT component will operate more efficiently with N chosen to be a value that is a power of two.

If padding symbols are absent from the payload portion of an OFDM signal then it will not be possible to use Fast Fourier Transform based techniques and a slower discrete Fourier Transform would be required. For this reason, it is highly preferable that padding symbols are included where required.

FIG. 2 shows an example of a payload portion 13 comprising three OFDM symbols (15, 17, 19). The first two OFDM symbols (15, 17) are made up of data (constellation) symbols (e.g. QAM, PSK symbols) only. The final OFDM symbol 19 however does not comprise enough data symbols 21 (denoted as d₀, d₁, d₂ in FIG. 2) to constitute a full OFDM symbol. Padding zero symbols 23 are therefore included within the final OFDM symbol 19 in order to bring the total number of bits in the payload portion 13 up to an integer number of OFDM symbols (in this case three OFDM symbols).

The insertion of redundant preambles, midambles and postambles results in a costly overhead that can significantly affect the overall data rate of the communication system. It is therefore an object of the present invention to substantially overcome or mitigate the above problem.

Accordingly in a first aspect the present invention provides an OFDM signal transmitted from an OFDM transmitter, the signal having a payload portion comprising a first number of data symbols and a second number of padding symbols such that the combined number of data symbols and padding symbols equates to an integer number of OFDM symbols and wherein the padding symbols comprise training symbols.

The use of the padding symbols described in the prior art is wasteful since they serve no purpose other than allowing OFDM modulation to be employed. The present invention therefore proposes that the padding symbols are replaced with training symbols. This enables the requirement that an integer number of OFDM symbols are present in the system while facilitating the estimation of certain parameters/tasks such as channel estimation, frequency offset tracking and timing offset tracking.

The present invention possesses several advantages over conventional techniques.

First, no additional resources are utilized for transmission beyond that specified by the upper layers for data transmission. This is especially important when considering latency-critical real-time applications and multiple antenna systems where one additional postamble consists of possibly hundreds of training samples, which is a very large overhead.

Furthermore, this solution is tuneable. For example, in a packet based transmission scheme, if the transmitter deems it unnecessary to re-estimate the channel with each transmitted packet, it can use the extra symbol spaces for something other than channel estimation without wasting system resources with a postamble. The transmitter's decision can be conveyed to the receiver in the header of the packet.

Finally, some specifications, such as the multi-band OFDM alliance (MBOA) proposal, require a large amount of training to estimate the channel and perform synchronization. If a previous estimate of the channel is available through the use of the proposed technique, and the system is coarsely synchronized at the beginning of a packet, such overhead can be reduced, if not eliminated.

The location of the padding training symbols may vary depending on the system configuration. Conveniently, the padding symbols may be located at the end of the last OFDM symbol in cases where the payload comprises a plurality of OFDM symbols.

Alteratively, the padding training symbols may be spread throughout the last OFDM symbol or even throughout the entire payload portion of the signal.

Conveniently for OFDM signals transmitted in a packet format the number and location of the padding symbols can be included in the header portion of the packet.

The training symbols included as padding can conveniently be used for channel estimation or other estimation tasks such as frequency offset tracking and timing offset tracking.

In a second aspect of the present invention there is provided an OFDM transmitter having at least one transmit antenna, said OFDM transmitter being configured to transmit from each of the at least one transmit antennas an OFDM signal comprising a payload portion having a first number of data symbols and a second number of padding symbols such that the combined number of data symbols and padding symbols equates to an integer number of OFDM symbols and wherein the padding symbols comprise training symbols.

The OFDM signal transmitted by the OFDM transmitter may have all the features of the OFDM signal described in relation to the first aspect of the invention.

The OFDM transmitter preferably comprises a look up table which stores the number of training symbols that can be inserted into a packet containing a given amount of data This data can be easily pre-computed.

According to a third aspect of the present invention there is provided an operating program which, when loaded into a communications device, causes the device to become one according to the second aspect of the present invention.

According to a fourth aspect of the present invention there is provided a method of providing an OFDM signal from an OFDM transmitter having at least one transmit antenna comprising adding training symbols to the data symbols of a payload portion of the OFDM signal to be transmitted such that the total number of training symbols and data symbols equates to an integer number of OFDM signals.

According to a fifth aspect of the present invention there is provided an OFDM receiver configured to receive an OFDM signal according to the first aspect of the invention when transmitted by an OFDM transmitter according to a second aspect of the present invention.

According to a sixth aspect of the present invention there is provided an OFDM data transmission system comprising an OFDM transmitter configured to transmit the OFDM signal of the first aspect of the present invention and an OFDM receiver configured to receive the OFDM signal.

Preferably the OFDM receiver includes a channel estimator to estimate the channel response between the transmitter and receiver.

In instances where the number of training symbols that can be appended to the data payload is low or the number of transmit antennas is high it may not be possible to estimate the full channel response. For example:
i) if there is a single transmit antenna and the number of symbols is too low then the channel may be estimated only on those subcarriers that carry training symbols.
ii) If the number of transmit antennas is too high (i.e. greater than 1 and the number of training symbols is not sufficient) then the channel between a subset of the transmit antennas and the receive antennas may be estimated.

The above-described operating program to implement the above-described OFDM transmitters and methods may be provided on a data carrier such as a disk, CD- or DVD-ROM, programmed memory such as read-only memory (Firmware), or on a data carrier such as optical or electrical signal carrier. For many applications embodiments of the above-described transmitters, and transmitters configured to function according to the above-described methods will be implemented on a DSP (Digital Signal Processor), ASIC (Application Specific Integrated Circuit) or FPGA (Field Programmable Gate Array). Thus code (and data) to implement embodiments of the invention may comprise conventional program code, or microcode or, for example, code for setting up or controlling an ASIC or FPGA. Similarly the code may comprise code for a hardware description language such as Verilog (Trade Mark) or VHDL (Very high speed integrated circuit Hardware Description Language). As the skilled person will appreciate such code and/or data may be distributed between a plurality of coupled components in communication with one another.

The present invention will now be described with reference to the following non-limiting preferred embodiments in which:

FIG. 1, discussed hereinbefore, shows an example of packet structure in OFDM systems.

FIG. 2, also discussed hereinbefore, shows an example of padding “zero” symbols to fill an OFDM symbol.

FIG. 3 shows an example of an OFDM signal according to the present invention.

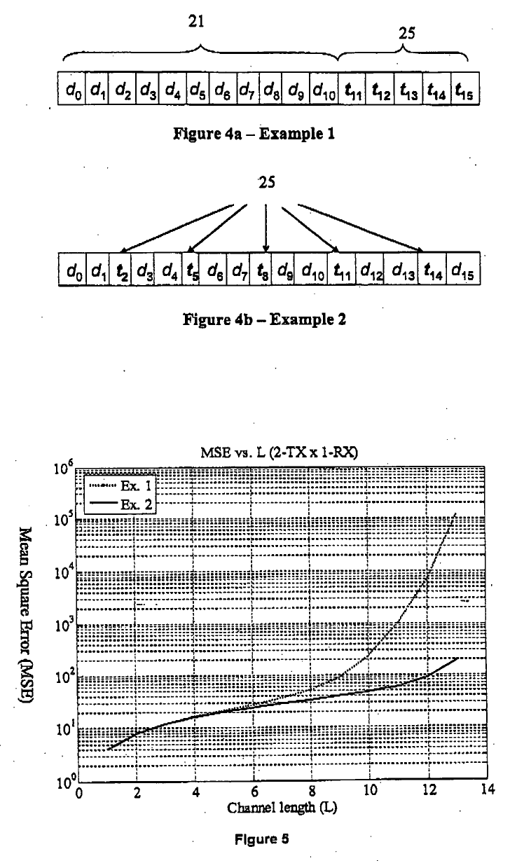

FIG. 4 shows two different examples of arrangements for training and data symbols within an OFDM symbol.

FIG. 5 shows a plot of Mean Square Error of a Least Squares channel estimate plotted against channel impulse length for the two examples of FIG. 4.

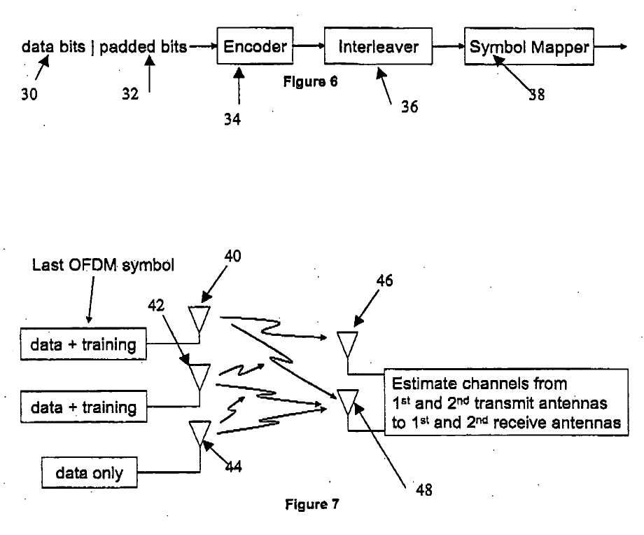

FIG. 6 shows an encoding and interleaving process procedure as used in prior art systems.

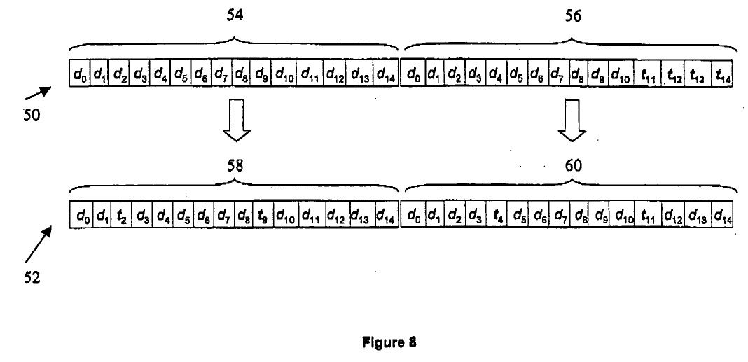

FIG. 7 shows an example of transmitting training symbols from a subset of transmit antennas.

FIG. 8 shows training'symbols interleaved throughout a signal packet.

As noted above, in prior art systems, training sequence data is often included within the preamble portions of the transmitted packet (and also the mid and post amble portions if present).

In the present invention training symbols are instead included as padding symbols within the data portion of the OFDM signal packet. These training symbols can be used for channel estimation or for other estimation tasks such as carrier frequency offset tracking and timing offset tracking.

FIG. 3 shows an example of an OFDM signal according to the present invention in which a payload portion of an OFDM signal comprises three OFDM signals. As in

FIG. 2 (Note: like numerals denote like features), the first two OFDM signals 15, 17 comprise data symbols only. The last OFDM symbol 19 however comprises a number of constellation symbols 21 (again shown as d₀, d₁, d₂ . . . ) and a number of padding training symbols 25 (denoted as t₀, t₁, t₂ in the Figure).

The number of training symbols 25 inserted into the payload 13 is chosen in order to satisfy the requirement of an integer number of OFDM symbols.

FIG. 4 shows two examples of OFDM signals comprising padding training symbols. In Example 1, shown in FIG. 4a, the padding symbols 25 are appended to the end of the OPDM symbol (as also shown in FIG. 3). In Example 2, shown in FIG. 4b, the padding training symbols 25 are distributed evenly throughout the OFDM symbol.

The location and design of the symbols can have an affect on the performance of a communication system and can, for example, affect the performance of channel estimation techniques such as least-squares (LS) estimation (see for example, E. Larsson and J. Li. “Preamble design for multiple-antenna OFDM-based WLANs with null subcarriers,” IEEE Signal Processing Letters, vol. 8, no. 11, Nov. 2001).

FIG. 5 shows a plot of mean square error (MSE) of a channel estimate versus channel length (L) for the two OFDM symbol structures shown in FIG. 4. It can be seen that Example 2, which distributes training symbols throughout the OFDM symbol, has a lower MSE than Example 1 (training symbols at the end of the OFDM symbol only) as the value of L increases.

The number of padding symbols that can be inserted into the OFDM signal can vary in number as well as their location.

The payload size of a packet based signal can vary dramatically. As a consequence the number of data symbols in the payload and therefore the number of padding symbols will also vary. For a system with M transmit antennas and N data symbols per OFDM symbol, the number of additional padding symbols that can be appended to the packet can vary from zero (for the instances where the total number of data symbols is actually an integer number of OFDM symbols) to MN-1.

The number of training symbols that can be appended to a packet containing a given amount of data can easily be pre-computed and stored in a look-up table at the transmitter and the receiver. Many packet-based systems include information regarding the length of the packet in the packet header, Since the header is received at the beginning of the packet (see FIG. 1), this information can be used at the receiver to derive how much training was actually transmitted and also the location of the training symbols, which must be known before the receiver can use the training symbols to estimate the channel.

For the packet structures depicted in FIGS. 3 and 4 all symbols but the last OFDM symbol in the packet can be processed in the usual manner at the receiver (i.e. equalised, detected, decoded etc.). The training symbols in the last OFDM symbol are then used to estimate the channel (or perform one of the other estimation tasks noted above). For channel estimation, any conventional technique can be employed such as LS or minimum mean-square error (MMSE) channel estimation. Such algorithms will be well-known to the skilled person but, for completeness, reference may also be made to Lee and Messerschmitt, “Digital Communication”, Kluwer Academic Publishers, 1994 which discusses the LMS algorithm.

It is noted that the subcarriers in the last OFDM symbol over which data is transmitted are treated by the estimation device as “null” subcarriers, i.e. the channel estimator assumes that no training symbols were transmitted on these tones.

Some communication specifications require the data bit and padding bits to be encoded and interleaved prior to mapping the bits to constellation symbols and subsequently arranging them into OFDM symbols. Such a scheme is illustrated in FIG. 6 in which data bits 30 and padding bits 32 are passed first to an encoder 34, then to an interleaver 36 and finally to a symbol mapper 38.

Such an interleaving step will inherently distribute encoded padding bits throughout the packet. The present invention may be used in a system that comprises interleaving in the following manner:
1. Encode the data and the padding bits as usual
2. Interleave the encoded data bits, but not the encoded padding bits
3. Map the interleaved, encoded data bits to constellation symbols (such as PSK or QAM symbols)
4. Replace the encoded zero bits with an appropriate number of training symbols, the number of which is determined by

$${N}_{t} = ⌊ MN - \frac{1}{{n}_{bps}} ( ⌈ \frac{{n}_{d}}{R} ⌉ mod ( {MNn}_{bps} ) ) ⌋$$
where n_{bps} is the number of bits per constellation symbol (e.g. n_{bps}=2 for QPSK), n_{d} is the number of bits in the payload of the packet excluding padding bits (this includes tail bits for resetting the encoder and frame check sequence (FCS) bits), and R is the code rate that is used. It is noted that the above equation uses the following notation, └ ┘ and ┌ ┐—the notation └x┘ denotes the integer part of the variable x and the notation ┌x┐ signifies the rounding of x upwards towards infinity.

The arrangement of the symbols in such a system can be determined by using a lookup table as previously discussed.

Some channel estimation techniques are limited by the number of transmit antennas M, the number of training symbols Nₜ and the length of the channel impulse response L (the channel impulse response being the inverse Fourier Transform of the channel frequency response). For LS channel estimation in OFDM systems the full channel response can only be estimated if
Nₜ≧ML

Thus, in cases where the number of training symbols that can be included in the data payload is low and/or the number of transmit antennas is high, it may not be possible to estimate the entire channel. In this case, a couple of options are available:
1. If M=1 (i.e. there is only one transmit antenna), the channel may be estimated only on those subcarriers that hold training samples. Although interpolation over the other subcarriers to retrieve the channel estimate for those tones is possible, it may not result in an accurate channel estimate.
2. If M>1, interpolation over all subcarriers will not be possible. Alternatively, the channels between a subset of the transmit antennas and the receive antenna(s) may be estimated. This effectively reduces M, which relaxes the bound given by the equation above. In this case, it may be possible to only transmit training samples from that subset of transmit antennas in question. The receiver can be told the identity of this subset in the header of the packet. Although the entire channel cannot be estimated with this method in one OFDM symbol, the partial estimate that is provided can still be used.

FIG. 7 depicts Option 2 above. In FIG. 7 three transmit antennas (40, 42, 44) transmit to two receive antennas (46, 48). For each-of the three transmit antennas (40, 42, 44) the last OFDM symbol is shown. For the top two antennas (40, 42) the last OFDM symbol comprises data and training symbols. The third antenna 44 however transmits data symbols only. The receiver can estimate the channel in the subset of transmit antennas comprising the top two antennas (40, 42).

A further implementation of the present invention includes an additional symbol interleaving step that can be applied to the packet comprising the data symbols and the training symbols.

FIG. 8 illustrates an example of this Tier implementation. FIG. 8 shows two signal streams. Both streams comprise two OFDM symbols. In the top stream the training symbols are located at the end of the last OFDM symbol only. An additional interleaving step results in the lower signal stream in which the training symbols have now been distributed throughout the payload portion of the signal.

The additional interleaving step places the training symbols in (possibly) non-adjacent positions throughout the packet. Each resulting OFDM symbol therefore has a number of symbols that can be used to estimate the channel and/or track parameters such as frequency offset. As before, information about the structure of these symbols can be conveyed to the receiver through the header of the packet.

1. An OFDM signal transmitted from an OFDM transmitter, the signal having a payload portion comprising a first number of data symbols and a second number of padding symbols such that the combined number of data symbols and padding symbols equates to an integer number of OFDM symbols and wherein the padding symbols comprise training symbols.

2. An OFDM signal as claimed in claim 1 wherein the payload comprises a plurality of OFDM symbols and the padding symbols are inserted at the end of the last OFDM symbol.

3. An OFDM signal as, claimed in claim 1 wherein the payload comprises a plurality of ODM symbols and the padding symbols are spread throughout the last OFDM symbol.

4. An OFDM signal as claimed in claim 1 wherein the payload comprises a plurality of OFDM symbols and the padding symbols are spread throughout the entire payload.

5. An OFDM signal as claimed in claim 1 wherein the signal is formed in a packet format, the packet comprising the payload portion and a header portion, the header portion including information relating to the number and arrangement of padding symbols.

6. An OFDM signal as claimed in claim 1 wherein the training symbols are adapted for channel estimation.

7. An OFDM signal as claimed in claim 1 wherein the training symbols are adapted for carrier frequency offset tracking or timing offset tracking.

8. An OFDM transmitter having at least one transmit antenna, said OFDM transmitter being configured to transmit from each of the at least one transmit antennas an OFDM signal comprising a payload portion having a first number of data symbols and a second number of padding symbols such that the combined number of data symbols and padding symbols equates to an integer number of OFDM symbols and wherein the padding symbols comprise training symbols.

9. An OFDM transmitter as claimed in claim 8 wherein the payload comprises a plurality of OFDM symbols and the padding symbols are inserted at the end of the last OFDM symbol.

10. An OFDM transmitter as claimed in claim 8 wherein the payload comprises. a plurality of OFDM symbols and the padding symbols are spread throughout the last OFDM symbol.

11. An OFDM transmitter as claimed in claim 8, wherein the payload comprises a plurality of OFDM symbols and the padding symbols are spread throughout the entire payload.

12. An OFDM transmitter as claimed in claim 8 wherein the signal is formed in a packet format, the packet comprising the payload portion and a header portion, the header portion including information relating to the number and arrangement of padding symbols.

13. An OFDM transmitter as claimed in claim 8 wherein the transmitter comprises a look-up table, said table comprising information relating to the number of training symbols that can be included in the OFDM signal for a packet comprising a given amount of data symbols.

14. An OFDM transmitter as claimed in claim 8 wherein the training symbols are adapted for channel estimation.

15. An OFDM transmitter as claimed in claim 8 wherein the training symbols are adapted for carrier frequency offset tracking or timing offset tracking.

16. An operating program which, when loaded into a communications device, causes the device to become one as claimed in claim 8.

17. An operating program as claimed in claim 16 carried on a carrier medium.

18. An operating program as claimed in claim 17, wherein the carrier medium is a transmission medium.

19. An operating program as claimed in claim 17, wherein the carrier medium is a storage medium

20. A method of providing an OFDM signal from an OFDM transmitter having at least one transmit antenna comprising adding training symbols to the data symbols of a payload portion of the OFDM signal to be transmitted such that the total number of training symbols and data symbols equates to an integer number of OFDM symbols.

21. An OFDM receiver configured to receive an OFDM signal as claimed in claim 1 when transmitted by an OFDM transmitter of claim 9.

22. An OFDM receiver as claimed in claim 21 wherein the receiver comprises a look-up table, said table comprising information relating to the number of training symbols that can be included in an OFDM signal packet comprising a given amount of data symbols.

23. An OFDM data transmission system comprising an OFDM transmitter configured to transmit the OFDM signal of claim 1 and an OFDM receiver configured to receive the OFDM signal.

24. An OFDM data transmission system according to claim 23 wherein the OFDM transmitter comprises one transmit antenna and the OFDM receiver comprises a channel estimator, the estimator configured to estimate the channel on subcarrier containing training symbols only.

25. An OFDM transmission system as claimed in claim 24 wherein the channel estimator derives a full channel estimate across all subcarrier by interpolation of channel values for subcarriers without training symbols.

26. An OFDM transmission system as claimed in claim 23 wherein the OFDM transmitter comprises more than one transmit antenna and the OFDM receiver comprises a channel estimator and the number of training symbols transmitted in the OFDM signal is less than ML, where M=number of transmit antennas and L=length of the channel impulse response, the channel estimator being configured to estimate the channel over a predetermined subset of the transmit antennas.
